(19) United States
(12) Patent Application Publication
(10) Pub. No.: US 2013/0300632 A1
(43) Pub. Date: Nov. 14, 2013

(54) DISPLAY SYSTEM, DISPLAY METHOD AND PORTABLE ELECTRONIC DEVICE

(71) Applicant: HON HAI PRECISION INDUSTRY CO., LTD., New Taipei (TW)

(72) Inventor: CHI-HUNG LEE, New Taipei (TW)

(73) Assignee: HON HAI PRECISION INDUSTRY CO., LTD., New Taipei (TW)

(21) Appl. No.: 13/723,209

(22) Filed: Dec. 21, 2012

(30) Foreign Application Priority Data
May 8, 2012 (TW) 101116405

(51) Int. Cl. G06F 3/14

(52) U.S. Cl. CPC G06F 3/1438
USPC 345/1.1

(57) ABSTRACT

A portable electronic device includes a storage unit, a data obtaining unit, a display unit, a display control unit, and a control unit. The display control unit controls the display unit to display data obtained from the storage unit by the data obtaining unit. The control unit stores undisplayed portion of data that is not displayed on the display unit. The communicating unit communicates with another portable electronic device, and transmits the undisplayed portion to the another portable electronic device for allowing the another portable electronic device to display the undisplayed portion of data.

### BACKGROUND

1. Technical Field

The present disclosure relates to a display system, a display method and a portable electronic device.

2. Description of the Related Art

Portable electronic devices employ display screens for displaying data and image for users. Sometimes, the area of the display screen is not large enough for displaying large size data and image. The user has to drag on the display screen to read the total data or image, which results in an inconvenient operation.

### BRIEF DESCRIPTION OF THE DRAWING

The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a diagram block of a display system, according to an exemplary embodiment.

FIG. 2 is a flowchart of a display method, according to an exemplary embodiment.

### DETAILED DESCRIPTION

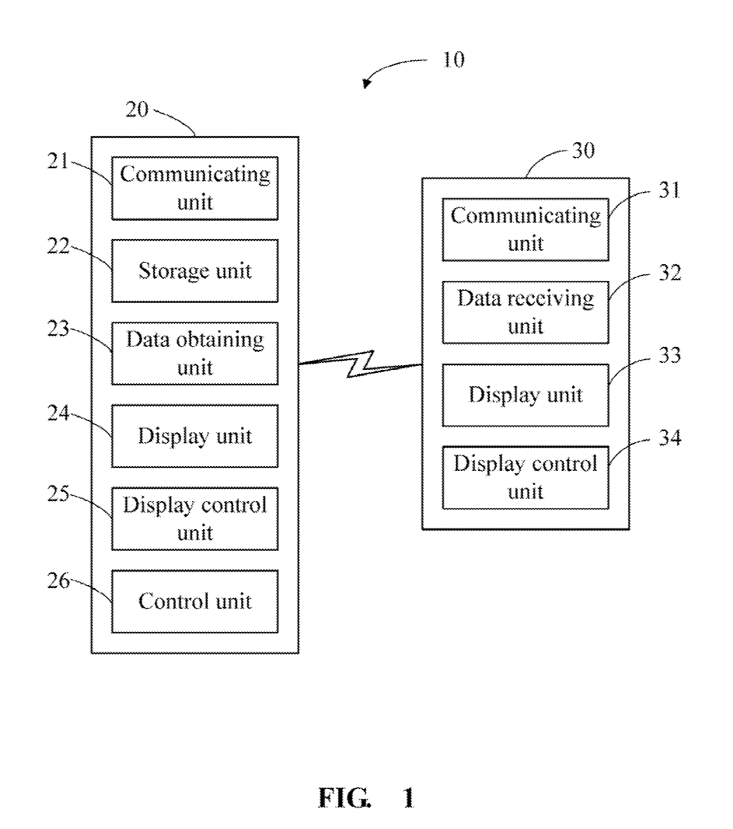

FIG. 1 shows a display system 10 of the embodiment. The display system 10 includes a first portable electronic device 20 and a second portable electronic device 30. The first portable electronic device 20 is capable of communicating with the second portable electronic device 30 within a predetermined range via a wireless network, such as Bluetooth and Wi-Fi.

The first portable electronic device 20 includes a communicating unit 21, a storage unit 22, a data obtaining unit 23, a display unit 24, a display control unit 25, and a control unit 26. The storage unit 22 is configured for storing data which can be displayed on the display unit 24. The data obtaining 23 is configured for obtaining the data from the storage unit 22 in response to an operation. The display control unit 25 is configured for controlling the display unit 24 to display the data obtained. The control unit 26 is configured for determining whether the obtained data is totally displayed on the display unit 24. When a portion of data that is not displayed on the display unit 24, the control unit 26 stores the undisplayed portion, and further generates an enable signal. The communicating unit 21 searches the second portable electronic device 30 and establishes a communication with the second portable electronic device 30 in response to the enable signal. The display control unit 25 controls the display unit 24 to display an image of the second portable electronic device 30 when the communication between the first portable electronic device 20 and the second electronic device 30 has been established. The image of the second portable electronic device 30 may be an icon which is mapped to the second portable electronic device 30. When the user selects the image of the second portable electronic device 30, the control unit 26 controls the communicating unit 21 to transmit the undisplayed portion of to the second portable electronic device 30.

In an alternative embodiment, the control unit 26 provides a prompt information when the data is not totally displayed on the display unit 24, the prompt information prompts the user to determine whether the undisplayed portion of data is displayed on the second portable electronic device 30. If yes, the control unit 26 generates a signal in response to the selection. The communicating unit 21 searches the second portable electronic device 30 and establishes a communication with the second portable electronic device 30 in response to the enable signal generated by the control unit 26.

The second portable electronic device 30 includes a communicating unit 31, a data receiving unit 32, a display control unit 33, and a display unit 34. The data receiving unit 32 receives the undisplayed portion of data transmitted by and from the first portable electronic device 20 via the communicating unit 31. The display unit control unit 33 controls the display unit 34 to display the undisplayed portion of data, therefore the display unit 24 and the display unit 34 cooperatively displays the total data obtained from the storage unit 21.

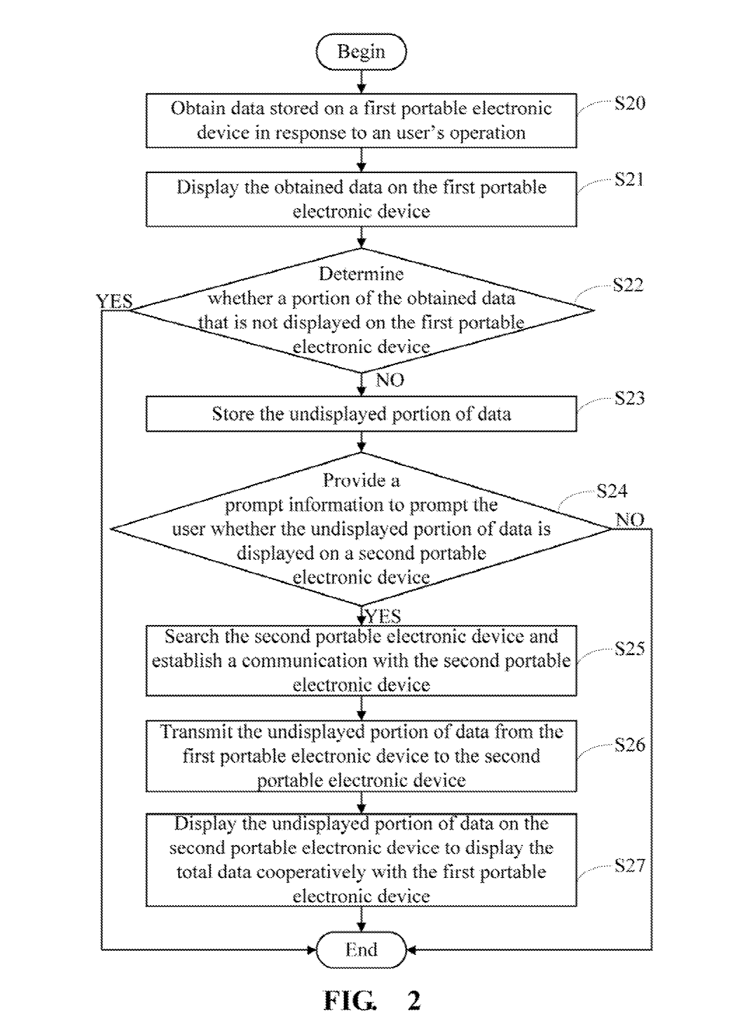

Referring to FIG. 2, a flowchart of a display method is provided. The display method is executable in the display system of FIG. 1.

In step S20, the data obtaining 23 obtains the data from the storage unit 22 in response to the operation.

In step S21, the display control unit 25 controls the display unit 24 to display the data obtained.

In step S22, the control unit 26 determines whether the obtained data is totally displayed on the display unit 24, if yes, the procedure ends, otherwise, the procedure goes to step S23.

In step S23, the control unit 26 stores the undisplayed portion of data.

In step S24, the control unit 26 provides a prompt information to prompt the user whether the portion of data not displayed on the display unit 24 needs to be displayed on the second portable electronic device 30. If yes, the procedure goes to step S25, otherwise, the procedure ends.

In step S25, the communicating unit 21 searches the second portable electronic device 30 and establishes a communication with the second portable electronic device 30. The display control unit 25 controls the display unit 24 to display an image of the second portable electronic device 30.

In step S26, the control unit 26 controls the communicating unit 21 to transmit the undisplayed portion of data to the second portable electronic device 30.

In step S27, the second portable electronic device 30 displays the portion of data on the display unit 34, thereby the display unit 24 and the display unit 34 cooperatively display the total data obtained from the storage unit 21.

It is understood that the present disclosure may be embodied in other forms without departing from the spirit thereof. Thus, the present examples and embodiments are to be considered in all respects as illustrative and not restrictive, and the disclosure is not to be limited to the details given herein.

What is claimed is:

1. A display system comprising a first portable electronic device and a second portable electronic device, the first portable electronic device comprising:
a storage unit configured for storing data;
a data obtaining unit configured for obtaining data from the storage unit in response to a user's operation;
a first display unit;
a first display control unit configured for controlling the first display unit to display the data obtained by the data obtaining unit;
a control unit configured for determining whether the obtained data is totally displayed on the first display unit, and, if a portion of data that is not displayed on the first display unit, storing the undisplayed portion, and further generating an enable signal;
a first communicating unit configured for communicating with the second portable electronic device in response to the enable signal, and transmitting the undisplayed portion of data to the second portable electronic device;
the second portable electronic device comprising:
a second communicating unit configured for communicating with the first communicating unit;
a data receiving unit configured for receiving the undisplayed portion of data transmitted by and from the first portable electronic device;
a second display unit;
a second display control unit configured for controlling the second display unit to display the undisplayed portion of data, thereby the first display unit and the second display unit cooperatively display the total data obtained from the storage unit.

2. The display system as claimed in claim 1, wherein the control unit is further configured for providing a prompt information when the data is not totally displayed on the first display unit, the prompt information prompts the user to determine whether the undisplayed portion of data is displayed on the second portable electronic device, and generating a signal when the undisplayed portion of data is determined to be displayed on the second portable electronic device, the first communicating unit searches the second portable electronic device and establishes a communication with the second portable electronic device in response to the enable signal generated by the control unit.

3. A display method employed in a display system, the display system comprising a first portable electronic device and the second portable electronic device, the method comprising:
obtaining data stored on the first portable electronic device in response to an user's operation;
displaying the obtained data on the first portable electronic device;
determining whether the obtained data is totally displayed on the first portable electronic device;
if there is a portion of the obtained data that is not displayed on the first portable electronic device, storing the undisplayed portion of data;
searching the second portable electronic device and establishing a communication with the second portable electronic device; and
transmitting the undisplayed portion of data from the first portable electronic device to the second portable electronic device, and
displaying the undisplayed portion of data on the second portable electronic device, thereby the first portable electronic device and the second portable electronic device cooperatively displaying the total data obtained.

4. The method as claimed in claim 3, wherein prior to “searching the second portable electronic device and establishing a communication with the second portable electronic device”, the method further comprises:
providing a prompt information to prompt the user to determine whether the undisplayed portion of data is displayed on the second portable electronic device.

5. A portable electronic device comprising:
a storage unit configured for storing data;
a data obtaining unit configured for obtaining data from the storage unit in response to a user's operation;
a display unit;
a display control unit configured for controlling the display unit to display the data obtained by the data obtaining unit;
a control unit configured for determining whether the obtained data is totally displayed on the display unit, and if there is a portion of data that is not displayed on the display unit, storing the undisplayed portion and further generating an enable signal;
a communicating unit configured for communicating with another portable electronic device in response to the enable signal, and transmitting the undisplayed portion of data to the another portable electronic device for allowing the another portable electronic device to display the undisplayed portion of data.

6. The portable electronic device as claimed in claim 5, wherein the control unit is further configured for providing a prompt information if the data is not totally displayed on the display unit, the prompt information prompts the user to determine whether the undisplayed portion of data is displayed on the another portable electronic device, and generating a signal when the undisplayed portion of data is determined to be displayed on the another portable electronic device, the communicating unit searches the another portable electronic device and establishes a communication with the another portable electronic device in response to the enable signal generated by the control unit.
